(19) United States
(12) Patent Application Publication
(10) Pub. No.: US 2026/0131433 A1
(43) Pub. Date: May 14, 2026

(54) Ratchet Wrench Head and Drive Mechanism

(71) Applicant: Tyan Chynis Industrial Co., Ltd., Taichung City (TW)

(72) Inventor: Chun Yu Lin, Taichung City (TW)

(21) Appl. No.: 19/076,136

(22) Filed: Mar. 11, 2025

(30) Foreign Application Priority Data
Nov. 8, 2024 (TW) 113142914

(51) Int. Cl. B25B 21/00; B25B 13/46; B25B 23/00

(52) U.S. Cl. CPC B25B 21/004; B25B 13/467; B25B 23/0028

(57) ABSTRACT

The present invention relates to a ratchet wrench head and associated drive mechanism pivotally coupled to a control handle. The structure comprises a wrench head housing, a drive assembly, and a transmission assembly. The drive assembly comprises a bevel gear shaft, while the transmission assembly comprises a transmission bevel gear which engages the bevel gear shaft for transmission. Both the drive and transmission assemblies are housed within the wrench head housing, allowing for adaptable speed configurations. In addition, the transmission assembly is equipped with a front ratchet shaft and a rear ratchet ring that engage to allow controlled unidirectional clockwise rotation while restricting counterclockwise movement. This configuration significantly enhances the mechanical robustness, operational reliability, and functional usability of the wrench.

### FIELD OF INVENTION

The present invention relates to an improved structural design for a ratchet wrench head and its associated drive mechanism, particularly in the field of tool head actuation and mechanical linkage systems.

### BACKGROUND OF THE PRESENT INVENTION

Conventional ratchet wrench head assemblies, as shown in FIG. 9, comprise a ratchet wrench head assembly 50 which includes a retention seat 51 and a drive head 52. The retention seat 51 is integrally formed with a handle shaft 510 and a perforated retention head 511. The handle shaft 510 is hollow and provides an internal passage to the retention head 511. An oscillating drive shaft 510A traverses the handle shaft 510 and terminates in an eccentrically mounted drive ball 510B. The retention head 511 integrates a ratchet pivot sleeve 511A with an underlying ball recess 511B. The drive ball 510B of the oscillating drive shaft 510A interfaces with the recess 511B to provide sliding engagement. The drive head 52 is structurally composed of a drive head body 520 and a side ratchet block 521, the latter incorporating multiple ratchet teeth 521A along its lateral surfaces and being pivotally attached to the drive head body 520. The drive head 52 is rotationally secured between the retention head 511 and the ratchet pivot sleeve 511A, with the side ratchet block 521 engaging the ratchet teeth within the ratchet pivot sleeve 511A. When the oscillating drive shaft 510A is actuated, the eccentric drive ball 510B induces oscillatory motion within the ratchet pivot sleeve 511A, resulting in periodic engagement with the side ratchet block 521 of the drive head 52. This configuration facilitates controlled incremental rotation of the drive head 52. However, the angle of engagement between the oscillating drive shaft 510A and the ratchet pivot sleeve 511A is inherently constrained, permitting only partial engagement with the side ratchet block 521. This limitation affects the overall actuation stability and safety. Moreover, since the rotational speed of the drive head 52 is inherently restricted. Attempts to increase its speed will result in excessive heat accumulation at the interface between the oscillating drive shaft 510A and the ratchet pivot sleeve 511A. Additionally, given the open structural configuration of the ratchet wrench head assembly 50, an insulating layer cannot be applied to the exterior of the retention seat 51, making it unsuitable for applications requiring electrical insulation, such as electric vehicle maintenance. Consequently, further structural refinement is required.

### SUMMARY OF THE PRESENT INVENTION

To address the limitations in structural durability, mechanical stability, and functional efficiency inherent in conventional ratchet wrench head configurations, the present invention introduces an advanced ratchet wrench head and associated drive mechanism.

The primary objective of the present invention is to provide a ratchet wrench head and its associated drive mechanism, pivotally coupled to a control handle. The structure comprises a wrench head housing, a drive assembly, and a transmission assembly. The wrench head housing is integrally formed with an upper transmission housing and a lower drive housing. The upper transmission housing includes a front opening, a transmission chamber, and a rear opening extending from front to back. The rear opening features an annular inner surface incorporating multiple positioning lugs along its periphery. The lower drive housing is hollow and includes a drive chamber in direct communication with the transmission chamber. The drive assembly comprises a bevel gear shaft, multiple drive bearings, and a hollow retaining disc. The bevel gear shaft is formed integrally with a vertical bevel gear and a drive shaft. The drive shaft is mounted within the drive bearings to facilitate rotation. The hollow retaining disc is compressed and secured around the lower boundary of the drive bearings. The transmission assembly comprises a front transmission assembly and a rear retention assembly. The front transmission assembly consists of a driver head, a front cover ring, a transmission bevel gear, a front ratchet shaft, and a retaining ring. The driver head incorporates a lateral guide slot, while the front cover ring features an internal positioning groove. The transmission bevel gear consists of a hollow shaft and a horizontal bevel gear. The front ratchet shaft has a terminal front ratchet teeth and a lateral guide pin hole that accommodates a guide pin. The driver head is inserted into the front ratchet shaft, with its guide slot engaging the guide pin to allow axial sliding adjustments. The hollow shaft of the transmission bevel gear is securely positioned within the positioning groove of the front cover ring, allowing controlled rotational motion. The front ratchet shaft is secured to the transmission bevel gear with the retaining ring mounted on the front ratchet shaft, pressing against the end surface of the transmission bevel gear to ensure structural cohesion. The rear retention assembly consists of a rear ratchet ring, a rear cover ring, and a pressing spring. The rear ratchet ring features rear ratchet teeth at one end and multiple alignment grooves along its periphery. The pressing spring, in a compressed and elastically responsive state, is situated between the rear ratchet ring and the rear cover ring. The driver head of the front transmission assembly extends through the rear ratchet ring, the pressing spring, and the rear cover ring. The transmission assembly is housed within the upper transmission housing of the wrench head housing. The front cover ring is anchored at the front opening, while the rear cover ring is secured at the rear opening. This configuration facilitates engagement between the front ratchet teeth of the front ratchet shaft and the rear ratchet teeth of the rear ratchet ring, and the pressing spring provides elastic engagement, allowing controlled clockwise rotation while restricting counterclockwise movement. The drive assembly is contained within the lower drive housing of the wrench head housing, where the hollow retaining disc is securely affixed against the inner wall of the drive chamber. The vertical bevel gear of the bevel gear shaft meshes with the horizontal bevel gear of the transmission bevel gear, providing an efficient mechanical linkage, and the bevel gear shaft is selectively engaged with the control handle to facilitate torque transmission.

In a preferred embodiment, the drive chamber of the wrench head housing incorporates a positioning recess at its end, with a stepped groove formed below the positioning recess. Once the bevel gear shaft is mounted within the multiple drive bearings, it is positioned within the recess. The hollow retaining disc is securely seated within the stepped groove, stabilizing the drive bearings and enhancing the versatility of the invention.

In another preferred embodiment, the end face of the drive shaft features a mounting hole which allows secure attachment to the driving end of the control handle, thereby optimizing mechanical integration and usability.

Furthermore, the mounting hole of the drive shaft may be configured in a square, hexagonal, or star-shaped profile, thereby improving compatibility with various tooling systems and increasing functional adaptability.

To further increase torque transmission efficiency, the front ratchet teeth and the rear ratchet teeth are designed with a progressively inclined negative angle. This configuration enhances meshing integrity by increasing the contact surface area and engagement force, thereby reinforcing mechanical durability and improving the versatility of the invention.

Additionally, the annular inner surface of the rear opening of the upper transmission housing includes a retention groove near its outer edge. The transmission assembly further comprises a spring clip that securely engages with the retention groove, ensuring a firm and stabilized fit within the transmission chamber. This feature enhances the reliability of the entire assembly and improves the versatility of the invention.

In another embodiment, the wrench head housing is provided with an outer insulating layer, enabling its use in electrically sensitive environments such as electric vehicle maintenance. This insulation enhances operational safety and extends the functional scope of the invention.

By integrating a control handle, whether manual, electric, or pneumatic, the present invention achieves superior mechanical durability, operational stability, and functional efficiency. The combination of the drive assembly and the transmission assembly within the wrench head housing allows for adaptable speed configurations. In addition, the transmission assembly incorporates the front ratchet shaft and the rear ratchet ring that interlock to allow controlled clockwise rotation while restricting counterclockwise movement. Together, these enhancements collectively contribute to the structural robustness, operational reliability, and extended service life of the system, making the invention highly suitable for industrial applications.

### BRIEF DESCRIPTION OF THE DRAWINGS

FIG. 1 is a perspective assembled view of the ratchet wrench head and its drive mechanism according to the present invention;

FIG. 2 is a perspective exploded view of the ratchet wrench head and its drive mechanism;

FIG. 3 is a cross-sectional view of the ratchet wrench head and its drive mechanism;

FIG. 4 is a reference view showing the clockwise and counterclockwise rotation of the ratchet wrench head and its drive mechanism;

FIG. 5 is a reference view showing the ratchet wrench head and its drive mechanism assembled on a manual driving tool;

FIG. 6 is a reference view showing the ratchet wrench head and its drive mechanism assembled on an electric driving tool;

FIG. 7 is a reference view showing the ratchet wrench head and its drive mechanism assembled on a pneumatic driving tool;

FIG. 8 is a reference view showing an embodiment of the wrench head housing of the ratchet wrench head and its drive mechanism provided with an outer insulating layer; and

FIG. 9 is a cross-sectional view of a conventional ratchet wrench head structure.

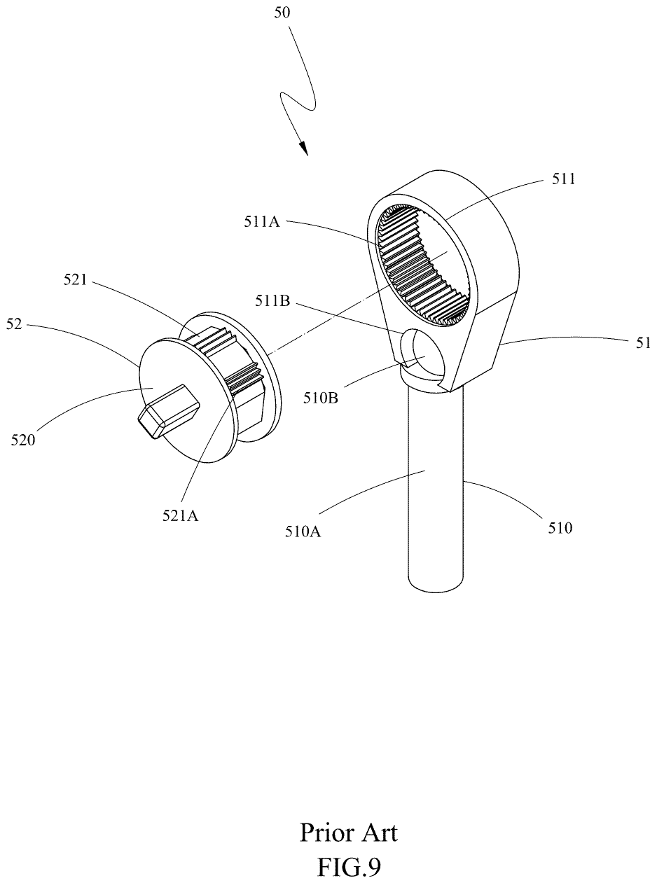

### DETAILED DESCRIPTION OF THE PREFERRED EMBODIMENTS

In order to provide a comprehensive understanding of the structure, functional characteristics, and other objectives of the present invention, the following preferred embodiments are described in detail with reference to the accompanying drawings. It should be noted that the illustrated embodiments serve an explanatory function and do not represent the sole limitations of the patent claims.

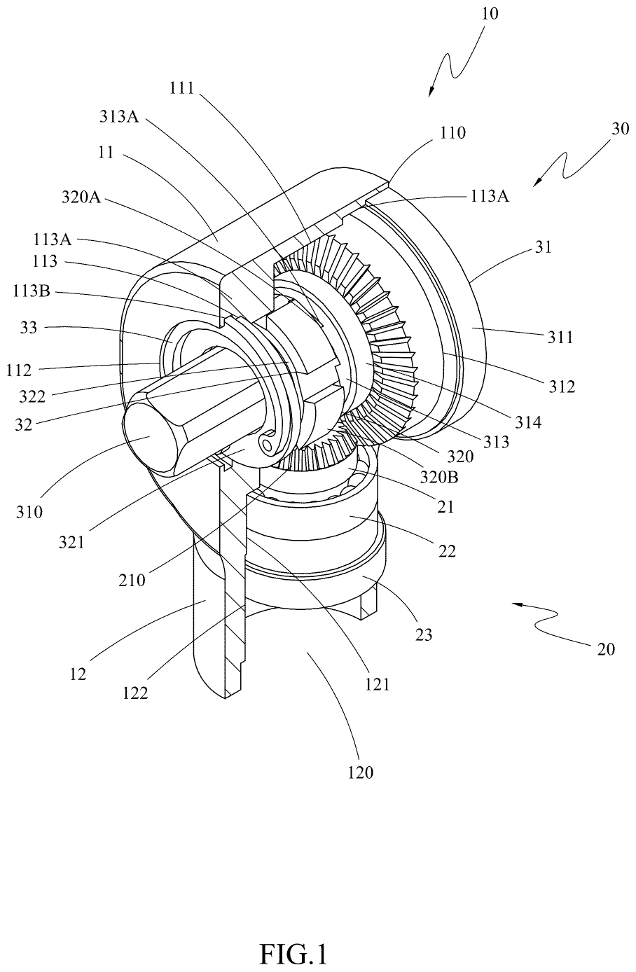

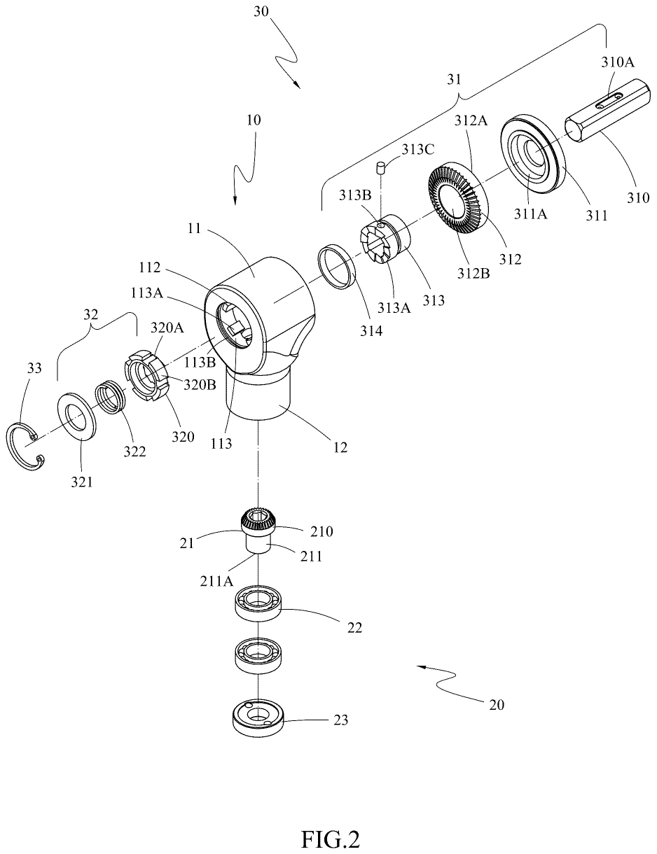

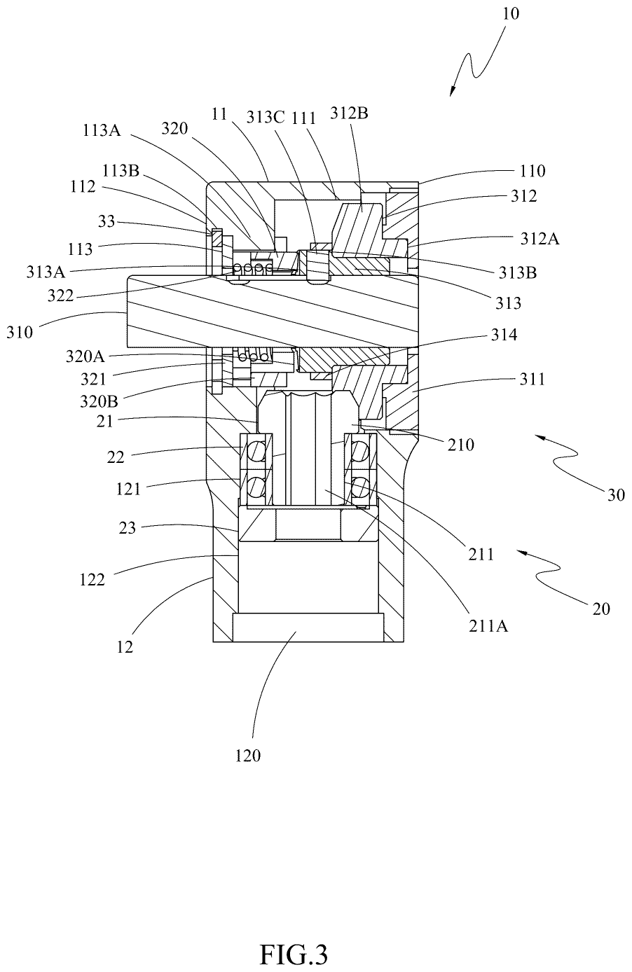

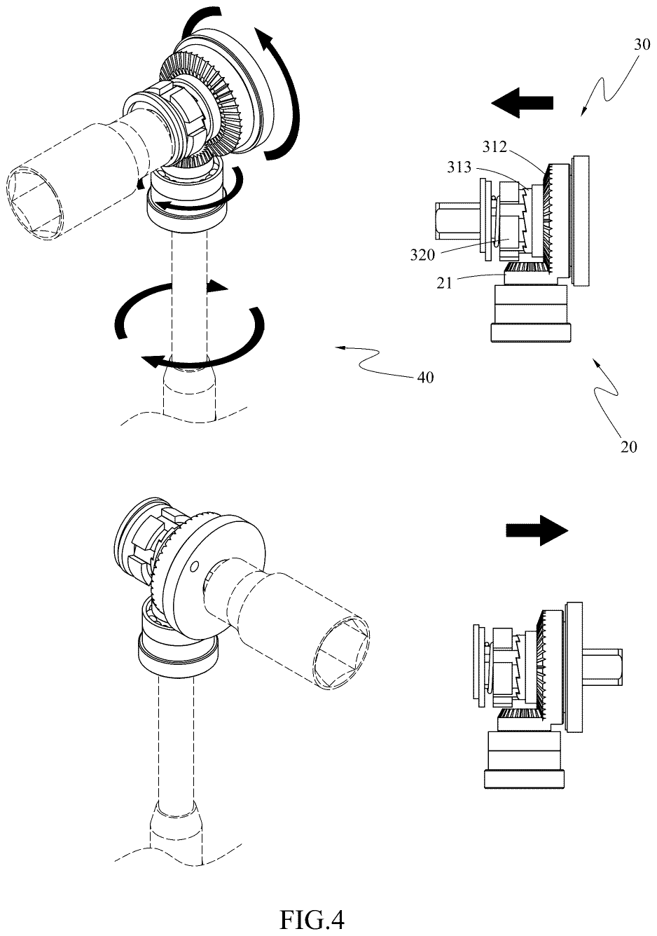

Referring to FIGS. 1 to 4 for a depiction of the assembled perspective, exploded perspective, cross-sectional, and operational reference views illustrating clockwise and counterclockwise rotation of the ratchet wrench head and its drive mechanism. The system is coupled to a control handle 40 and comprises:

A wrench head housing 10, integrally incorporating an upper transmission housing 11 and a lower drive housing 12. The upper transmission housing 11 extends from front to back, housing a front opening 110, a transmission chamber 111, and a rear opening 112. The rear opening 112 is delineated by an annular inner surface 113 having multiple positioning lugs 113A along its inner circumference. The lower drive housing 12 is structurally hollow, forming a drive chamber 120 which communicates with the transmission chamber 111.

A drive assembly 20, which comprises a bevel gear shaft 21, multiple drive bearings 22, and a hollow retaining disc 23. The bevel gear shaft 21 is monolithically structured, integrating a vertical bevel gear 210 and a drive shaft 211. The drive shaft 211 is mounted within the drive bearings 22 to facilitate rotation relative to the bearings 22. The hollow retaining disc 23 is positioned to secure around the lower boundary of the drive bearings 22.

A transmission assembly 30, consisting of a front transmission assembly 31 and a rear retention assembly 32. The front transmission assembly 31 includes a driver head 310, a front cover ring 311, a transmission bevel gear 312, a front ratchet shaft 313, and a retaining ring 314. The driver head 310 is laterally equipped with a guide slot 310A, while the front cover ring 311 is internally structured with a positioning groove 311A. The transmission bevel gear 312 comprises an integrally formed hollow shaft 312A and a horizontal bevel gear 312B. The front ratchet shaft 313 has terminal front ratchet teeth 313A and a lateral guide pin hole 313B, within which a guide pin 313C is positioned. The driver head 310 is inserted into the front ratchet shaft 313 and engages with the guide pin 313C via its guide slot 310A, thus permitting axial sliding adjustments. The hollow shaft 312A of the transmission bevel gear 312 is securely positioned within the positioning groove 311A of the front cover ring 311, ensuring controlled free rotation. The front ratchet shaft 313 is securely mounted within the transmission bevel gear 312, while the retaining ring 314 is mounted on the front ratchet shaft 313, pressing against the end surface of the transmission bevel gear 312 to secure the assembly. Additionally, the rear retention assembly 32 includes a rear ratchet ring 320, a rear cover ring 321, and a pressing spring 322. The rear ratchet ring 320 features rear ratchet teeth 320A at one end and multiple alignment grooves 320B along its periphery. The pressing spring 322, in a compressed and elastic return configuration, is situated between the rear ratchet ring 320 and the rear cover ring 321. The driver head 310 extends sequentially through the rear ratchet ring 320, the pressing spring 322, and the rear cover ring 321.

The transmission assembly 30 is housed within the upper transmission housing 11 of the wrench head housing 10, with the front cover ring 311 secured at the front opening 110 and the rear cover ring 321 secured at the rear opening 112. This configuration ensures engagement between the front ratchet teeth 313A of the front ratchet shaft 313 and the rear ratchet teeth 320A of the rear ratchet ring 320, and the pressing spring 322 in the rear retention assembly 32 provides a resilient engagement mechanism that enables clockwise rotation while restricting counterclockwise movement. The drive assembly 20 is mounted within the lower drive housing 12 of the wrench head housing 10, with the hollow retaining disc 23 anchored against the inner walls of the drive chamber 120. The vertical bevel gear 210 of the bevel gear shaft 21 meshes with the horizontal bevel gear 312B of the transmission bevel gear 312, thereby establishing a mechanical linkage, and the bevel gear shaft 21 selectively couples with the control handle 40, thereby facilitating torque transmission.

Through this structural design, the improved ratchet wrench head and its drive mechanism achieve operational efficiency and reliability.

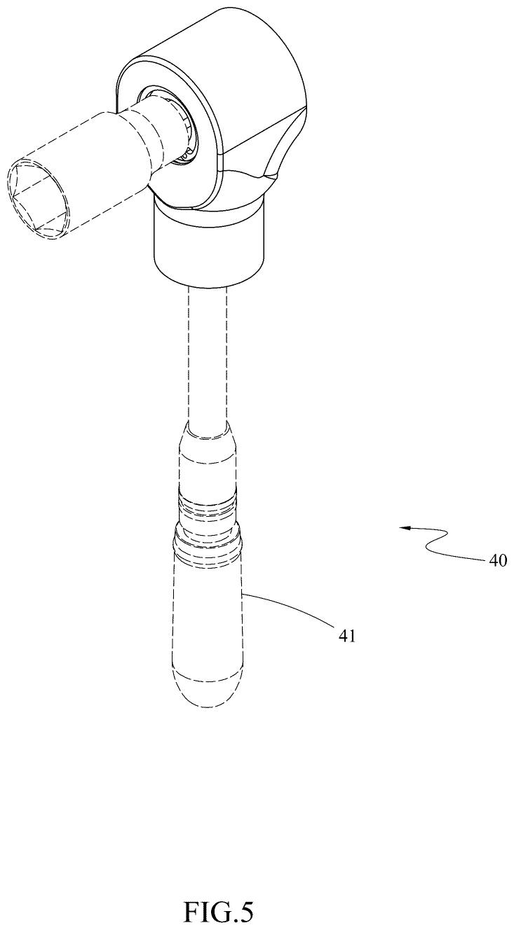

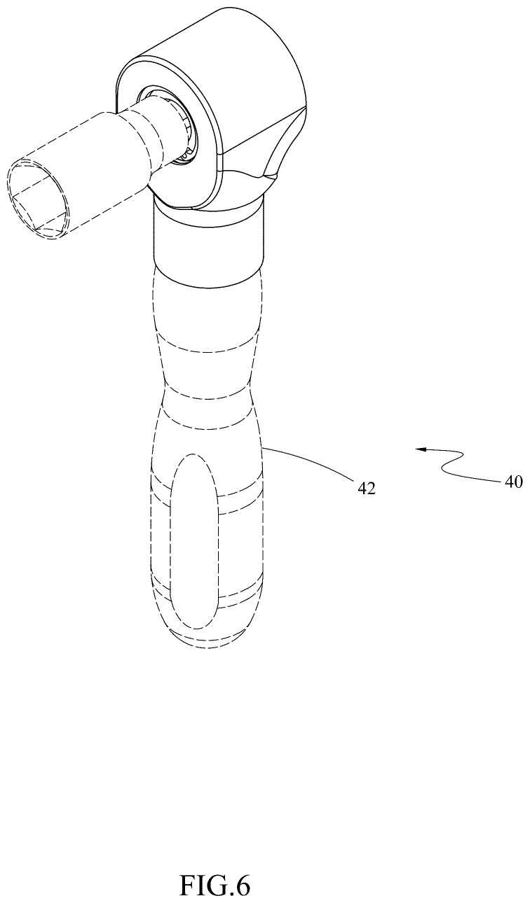

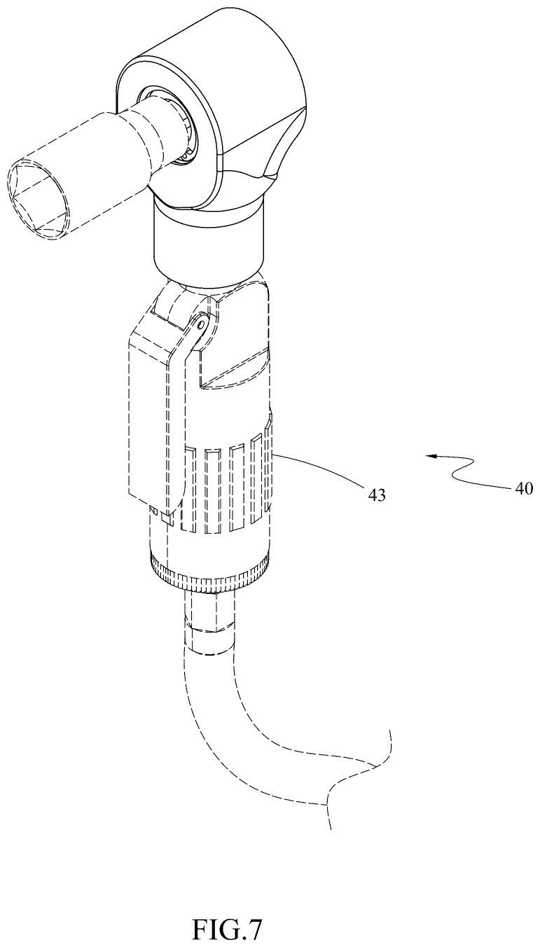

Referring to FIGS. 1 to 7, which illustrate the system in various configurations, including integration with manual, electric, and pneumatic tool control handles 41, 42, and 43, respectively. The overall assembly includes a wrench head housing 10, a drive assembly 20, and a transmission assembly 30. The drive assembly 20 incorporates a bevel gear shaft 21, while the transmission assembly 30 equips with a transmission bevel gear 312 which engages with the bevel gear shaft 21 for transmission. Both assemblies are housed within the wrench head housing 10 to allow adaptable speed configurations. The transmission assembly 30 further integrates a front ratchet shaft 313 and a rear ratchet ring 320, providing controlled unidirectional operation. This enhances the structural operating robustness, achieving structural durability, stability, and functional usability.

Referring to FIGS. 1 to 3, which illustrate the perspective assembled view, exploded view, and cross-sectional view of the ratchet wrench head and its drive mechanism. In a preferred embodiment, the drive chamber 120 of the lower drive housing 12 of the wrench head housing 10 incorporates a positioning recess 121 at its terminal end. Below this recess, a stepped groove 122 is configured to ensure stability. The bevel gear shaft 21 of the vertical drive assembly 20 is precisely positioned within the positioning recess 121 after being mounted within multiple drive bearings 22. The hollow retaining disc 23 is securely fitted within the stepped groove 122 to immobilize the drive bearings 22, thereby improving the overall structural integrity and extending the functional adaptability of the invention.

Referring to FIGS. 1 to 3, in a preferred embodiment, the end face of the drive shaft 211, which is integrated into the bevel gear shaft 21 of the vertical drive assembly 20, features a mounting hole 211A. This hole enables a secure attachment to the driving end of the control handle 40, thereby increasing operational efficiency and facilitating robust mechanical integration of the system.

As shown in FIGS. 1 to 3, the mounting hole 211A in the drive shaft 211 may be configured in a geometric profile such as square, hexagonal, or star-shaped (not shown). These variations enhance compatibility with various mechanical systems, broadening the scope of applications for the invention.

FIGS. 1 to 3 further illustrate refinements to the transmission mechanism, designed to provide optimal torque transmission stability. In a preferred embodiment, the front ratchet teeth 313A, situated on the end face of the front ratchet shaft 313, and the rear ratchet teeth 320A, situated on the corresponding end face of the rear ratchet ring 320, are designed with a progressively inclined negative angle. This configuration increases the interlocking force between the components by increasing their contact surface area, thereby strengthening the engagement integrity and extending the functional adaptability of the invention.

Continuing with FIGS. 1 to 3, in a preferred embodiment, the annular inner surface 113 of the rear opening 112 in the upper transmission housing 11 incorporates a retention groove 113B near its outer periphery. To complement this, the transmission assembly 30 is further equipped with a spring clip 33. When the transmission assembly 30 is inserted into the transmission chamber 111 of the upper transmission housing 11, the spring clip 33 is elastically secured within the retention groove 113B. This design ensures that the transmission assembly 30 remains firmly secured, thereby greatly enhancing its structural strength and operational reliability.

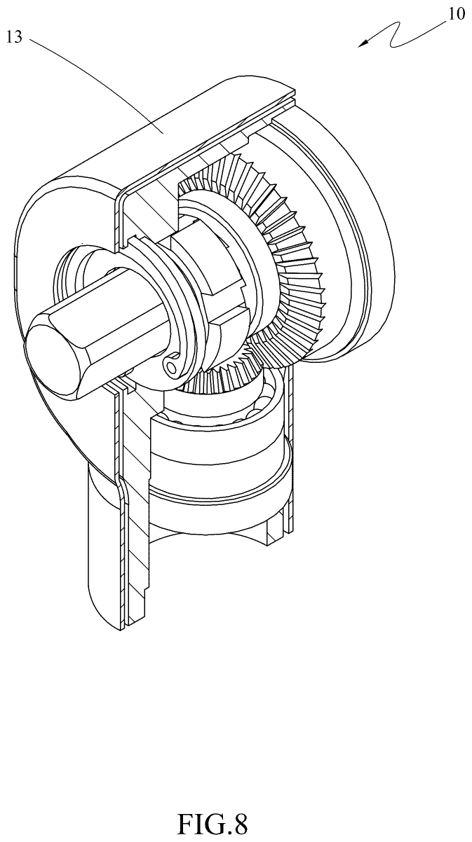

FIG. 8 illustrates an additional embodiment of the wrench head housing which incorporates an outer insulating layer 13. This insulating layer 13 broadens the functional applications of the invention by making it suitable for use in electrically sensitive environments, such as electric vehicle maintenance. This protective insulation enhances the safety of the user and extends the practical utility of the device.

In summary, the present invention can indeed achieve the aforementioned functions and objectives. Therefore, the present invention is submitted for patent protection in accordance with the law.

What is claimed is:

1. A drive mechanism for a ratchet wrench head, comprising:
a drive assembly, comprising a bevel gear shaft, multiple drive bearings, and a hollow retaining disc, where the bevel gear shaft is integrally formed with a vertical bevel gear and a drive shaft, the drive shaft features a mounting hole and is rotatably mounted within the drive bearings to allow controlled rotational motion, and the hollow retaining disc is compressed and secured around the lower boundary of the drive bearings; and
a transmission assembly, comprising a front transmission assembly and a rear retention assembly, wherein the front transmission assembly consists of a driver head, a transmission bevel gear, a front ratchet shaft, and a retaining ring, the driver head incorporates a lateral guide slot, the transmission bevel gear consists of an integrally formed hollow shaft and a horizontal bevel gear, and the front ratchet shaft has front ratchet teeth at its end and a lateral guide pin hole containing a guide pin; the driver head is inserted into the front ratchet shaft with the guide slot engaging the guide pin to facilitate axial sliding adjustments; the hollow shaft of the transmission bevel gear is positioned within the front cover ring to allow controlled rotational motion; the front ratchet shaft is housed within the transmission bevel gear with the retaining ring mounted on the front ratchet shaft, pressing against the end surface of the transmission bevel gear to secure the assembly; and the rear retention assembly includes a rear ratchet ring, a rear cover ring, and a pressing spring, wherein the rear ratchet ring features rear ratchet teeth on one end face and multiple alignment grooves along its periphery, the pressing spring, in a compressed and elastically responsive state, is situated between the rear ratchet ring and the rear cover ring, and the driver head of the front transmission assembly extends sequentially through the rear ratchet ring, the pressing spring, and the rear cover ring;
wherein the front ratchet teeth of the front ratchet shaft engage with the rear ratchet teeth of the rear ratchet ring, and the pressing spring in the rear retention assembly provides a resilient engagement mechanism that enables clockwise rotation while restricting counterclockwise movement; the vertical bevel gear of the bevel gear shaft meshes with the horizontal bevel gear of the transmission bevel gear to facilitate torque transmission.

2. The drive mechanism for the ratchet wrench head according to claim 1, wherein the mounting hole of the drive shaft is configured in a square, hexagonal, or star-shaped profile.

3. The drive mechanism for the ratchet wrench head according to claim 1, wherein the front ratchet teeth situated on the end face of the front ratchet shaft and the rear ratchet teeth situated on the corresponding end face of the rear ratchet ring are designed with a progressively inclined negative angle.

4. A ratchet wrench head pivotally coupled to a control handle, comprising:
a wrench head housing, integrally incorporating an upper transmission housing and a lower drive housing, wherein the upper transmission housing extends from front to back, housing a front opening, a transmission chamber, and a rear opening, the rear opening is designed with an annular inner surface having multiple positioning lugs along its inner circumference, and the lower drive housing is hollow and forms a drive chamber which communicates with the transmission chamber;
a drive assembly, comprising a bevel gear shaft, multiple drive bearings, and a hollow retaining disc, wherein the bevel gear shaft integrates a vertical bevel gear and a drive shaft, the drive shaft is mounted within the drive bearings to facilitate rotation relative to the drive bearings, and the hollow retaining disc is positioned to secure around the lower boundary of the drive bearings; and
a transmission assembly, comprising a front transmission assembly and a rear retention assembly, wherein the front transmission assembly consists of a driver head, a front cover ring, a transmission bevel gear, a front ratchet shaft, and a retaining ring, the driver head is laterally equipped with a guide slot, while the front cover ring is internally structured with an alignment groove, the transmission bevel gear consists of an integrally formed hollow shaft and a horizontal bevel gear, and the front ratchet shaft has front ratchet teeth at its end face and a lateral guide pin hole containing a guide pin; the driver head is inserted into the front ratchet shaft with the guide slot engaging the guide pin to facilitate axial sliding adjustments; the hollow shaft of the transmission bevel gear is positioned within the alignment groove of the front cover ring to allow controlled rotational motion; the front ratchet shaft is housed within the transmission bevel gear with the retaining ring mounted on the front ratchet shaft, pressing against the end surface of the transmission bevel gear to secure the assembly; and the rear retention assembly includes a rear ratchet ring, a rear cover ring, and a pressing spring, wherein the rear ratchet ring features rear ratchet teeth on one end and multiple alignment grooves along its periphery, the pressing spring, in a compressed and elastically responsive state, is situated between the rear ratchet ring and the rear cover ring, and the driver head of the front transmission assembly extends sequentially through the rear ratchet ring, the pressing spring, and the rear cover ring;
wherein the transmission assembly is housed within the upper transmission housing of the wrench head housing, with the front cover ring secured at the front opening and the rear cover ring secured at the rear opening to ensure engagement between the front ratchet teeth of the front ratchet shaft and the rear ratchet teeth of the rear ratchet ring, while the pressing spring in the rear retention assembly provides a resilient engagement mechanism that enables clockwise rotation and restricts counterclockwise movement; the drive assembly is secured within the lower drive housing of the wrench head housing, with the hollow retaining disc anchored against the inner walls of the drive chamber, and the vertical bevel gear of the drive assembly meshes with the horizontal bevel gear of the transmission assembly to establish a mechanical linkage, wherein the bevel gear shaft selectively couples with the control handle to facilitate the torque transmission.

5. The ratchet wrench head according to claim 4, wherein the drive chamber of the wrench head housing incorporates a positioning recess at its end, with a stepped groove formed below the positioning recess, the bevel gear shaft, once mounted within the multiple drive bearings, being positioned within the positioning recess, and the hollow retaining disc being securely seated within the stepped groove to stabilize the drive bearings.

6. The ratchet wrench head according to claim 5, wherein the end face of the drive shaft features a mounting hole which allows secure attachment to the driving end of the control handle.

7. The ratchet wrench head according to claim 6, wherein the mounting hole of the drive shaft is configured in square, hexagonal, or star-shaped profiles.

8. The ratchet wrench head according to claim 7, wherein the front ratchet teeth situated on the end face of the front ratchet shaft and the rear ratchet teeth situated on the corresponding end face of the rear ratchet ring are designed with a progressively inclined negative angle.

9. The ratchet wrench head according to claim 4, wherein the annular inner surface of the rear opening in the upper transmission housing includes a retention groove near its outer edge, and the transmission assembly further comprises a spring clip that securely engages with the retention groove to ensure firm positioning within the transmission chamber.

10. The ratchet wrench head according to claim 4, wherein the wrench head housing is provided with an outer insulating layer.
